(19) United States
(12) Patent Application Publication
(10) Pub. No.: US 2023/0320386 A1
(43) Pub. Date: Oct. 12, 2023

(54) ORANGE JUICE PRODUCTS WITH REDUCED ACIDITY AND TOTAL SUGAR CONTENT, AND A PROCESS FOR PRODUCING SAME

(71) Applicant: West Invest SA, Luxembourg City (LU)

(72) Inventors: Eric Reynaud, Luxembourg City (LU); Jacques Meurisse, Meylan (FR); Stanislas Baudouin, Perigny (FR)

(21) Appl. No.: 18/043,381

(22) PCT Filed: Aug. 31, 2021
(86) PCT No.: PCT/IB2021/057959

§ 371 Date: Feb. 28, 2023

Related U.S. Application Data
(60) Provisional application No. 63/072,976, filed on Sep. 1, 2020.

(51) Int. Cl. A23L 2/78; A23L 2/02; A23L 2/80; B01J 41/07; B01J 39/20; B01J 39/05; B01J 47/026

(52) U.S. Cl. CPC A23L 2/78; A23L 2/02; A23L 2/80; B01J 41/07; B01J 39/20; B01J 39/05; B01J 47/026

(57) ABSTRACT

It is disclosed orange juice products with reduced acidity, a deacidification system and a process for deacidifying orange juices comprising eluting the orange juice to be deacidified on a weak anion exchange resin to lead to a deacidified orange juice after elution; wherein the orange juice to be deacidified has an initial pH (pHi) and is eluted on said resin at a rate (BV/h) such that the deacidified orange juice has a pH (pHd) meeting the criteria: [pHi+(0.1-1)]<pHd<[pKa ascorbic acid+(0.1-0.5)].

### CROSS-REFERENCE TO RELATED APPLICATION

The present application is claiming priority from U.S. Provisional Application No. 63/072,976 filed September, 2021, the content of which is hereby incorporated by reference in its entirety.

### FIELD OF THE DISCLOSURE

The present invention relates to orange juice products with reduced acidity and total sugar-content, and a process for providing same.

### BACKGROUND

Orange juice products are highly popular with consumers due to both their taste and their nutritional value. However, orange juices can have a level of acidity that makes them disagreeable to persons with sensitive stomachs.

It has been known to add buffers and certain chemicals to increase the pH of orange juices, however those are undesirable extrinsic agents.

It has also been documented that a low pH orange juice does not favor the growth of certain pathogenic microorganisms such as Clostridium botulinum. Since these microorganisms are more likely to grow at a pH above 4.6, low acid juices may require a more aggressive heat treatment to prevent microbial growth, however such treatment may result in spoilage of certain sensitive compounds or the loss of aromas.

It is therefore desirable to reduce acidity (or increase pH) of orange juices, without additives and in a controlled manner in order to avoid the requirement of aggressive heat treatments.

Vitamin C, also known as ascorbic acid, is found in significant amount in orange juice, and is a vitamin found in various foods or dietary supplements. It has been used to prevent and treat scurvy and is an essential nutrient involved in the repair of tissue, certain enzymatic processes and is required for the functioning of several enzymes.

Ascorbic acid is a vinylogous acid and forms the ascorbate anion when deprotonated on one of the ring hydroxyls. Ascorbic acid readily forms its sodium, potassium, and calcium salts and are commonly used as antioxidant. It is therefore desirable to maintain ascorbic acid in orange juices.

Sucrose, glucose, and fructose are carbohydrates (or sugars) also found in natural state in orange juice. Sugar plays an important technical role as it contributes to the sweetness of a product and plays other roles such as flavour enhancement. However, there has been a great amount of pressure on the drinks industry to reduce their sugar content. Health related studies have shown a relationship between the intake of sweetened drinks and increased body weight in children and adults as a result of imbalanced energy intake. It has been discussed that drinking sweetened drinks for an extended period of time not only affects the body weight but also causes high level of triglycerides in blood.

In order to reduce the sugar content, certain approaches have been diluting the concentration of sugar with water. Another option is incorporating artificial sweeteners in place of natural sugars. However, an issue with these is the risk of altering the flavour and taste of the juice.

Sucrose is disaccharides which are hydrolyzed to glucose and fructose by sucrase at epithelium of small intestine. Sucrose is further known to be converted to glucose and fructose by heating and/or in the presence of acid, such as citric acid.

There is therefore still a need for orange juice products with reduced acidity and total sugar-content, and a process for providing same.

### SUMMARY

It is provided a process for deacidifying an orange juice comprising eluting the orange juice to be deacidified on a weak anion exchange resin to lead to a deacidified orange juice after elution; wherein the orange juice to be deacidified has an initial pH (pHi) and is eluted on said resin at a rate (BV/h) such that the deacidified orange juice has a pH (pHd) meeting the criteria: [pHi+(0.1-1)]<pHd<[pKa ascorbic acid+(0.1-0.5)].

In an embodiment, the process further comprises eluting a conditioning effective amount of a citric acid/citrate-containing aqueous solution on a strong cation exchange resin to provide a conditioned resin and subsequently eluting the orange juice to said conditioned resin; and recovering a first fraction of sugar-reduced orange juice after said step of eluting, wherein the first fraction is comprising about 30% to about 80% by weight of the total sugar of deacidified.

In another embodiment, the orange juice is loaded on the resin ranging from the 75% to 125% of the calculated loading capacity of said resin.

In a further embodiment, the orange juice is loaded on the resin ranging from the 75% to 100% of the calculated maximum loading capacity.

In an alternate embodiment, the weak anion exchange resin comprises ternary amines that are neutral at a pH greater than 10 and ionized at a pH lower than 10.

In an embodiment, the anion exchange resin is made of acrylic or styrene.

In another embodiment, the anion exchange resin is made of acrylic comprises a capacity between 1.6-3.2.

In a further embodiment, the anion exchange resin is made of a polystyrene matrix with a sulphonate (SO3-) functional group.

In an embodiment, the resin has an initial exchange speed equal to or greater than +0.10 unit of pH/minute observed after 5 minutes of contact of the juice with the resin in a volume ratio of 5:1 (juice:resin).

In another embodiment, the resin comprises particle sizes between 300 and 600 μm.

In an embodiment, the resin is AMBERLITE®.

In a further embodiment, the orange juice is circulated in an up flow column during elution.

In another embodiment, the pH of the deacidified juice at the exit of the column (pHe) does not exceed pH 5.

In an embodiment, the pHd value of the deacidified juice is comprised between about 4 and less than about 5.

In a further embodiment, the pHd value of the deacidified juice is comprised between from about 4.2 to about 4.6.

In an embodiment, the pHd value of the deacidified juice is about 4.6.

In a further embodiment, the process described herein further comprises a pretreatment of the orange juice to be deacidified.

In another embodiment, the pretreatment consists of clarifying the juice.

In an embodiment, the juice is clarified by centrifugation and/or filtration.

In a further embodiment, the juice is clarified to a turbidity below 500 NTU (Nephelometric Turbidity Unit).

In an embodiment, the juice is clarified to a turbidity below 100 NTU.

In another embodiment, the juice is clarified to a turbidity below 25 NTU.

In an embodiment, the process described herein further comprises the step of regenerating the anion exchange resin.

In a further embodiment, the process described herein further comprises concentrating said deacidified orange juice.

In an embodiment, the deacidified orange juice is concentrated by reverse osmosis or evaporation

It is additionally provided a juice deacidification system comprising a container configured to contain the juice to be deacidified; a pH meter within the container for measuring the pH of the juice in the container; at least one column comprising a resin, the column having an entry for allowing the juice to enter the column and eluate on the resin, and an exit for allowing the eluted juice to exit the column, circulate from an entry to get in contact with the resin, and to an exit; a pump for pumping the juice from the container to entry of the column; and a pH meter for measuring the pH of the juice at the exit of the column.

In a further embodiment, a flow rate command signal is provided to the pump adjusting circulation flow rate of said juice in the column.

In an embodiment, the juice to be deacidified is circulated in a loop between said container and the column.

In a further embodiment, the container is configured to contain the juice to be deacidified and for receiving the deacidified juice.

It is also provided a deacidified orange juice prepared by the process described herein.

In an embodiment, the deacidified orange juice described herein has a concentration index that is comprised between 3 and 65 degrees Brix.

In a further embodiment, the concentration index is comprised between about 10 Brix to 50 Brix.

### BRIEF DESCRIPTION OF THE FIGURES

FIG. 1: shows HPLC profile of a solution composed of citric and ascorbic acid as well as sucrose, glucose and fructose in the same solution;

FIGS. 2A and B: show HPLC profiles of (A) pressed juice (undiluted) and a commercial juice (½ dilution);

FIG. 3: is a graphical presentation of the pH measured over total bed volume during a classical elution of pressed orange juice on a weak anion exchange resin;

FIG. 4: is a graphical presentation of the pH measured over total bed volume eluted during a classical elution of a commercial orange juice on a weak anion exchange resin;

FIG. 5: is a schematically representation of a system for performing a high volumetric flow rate acid removal from orange juices in which the deacidification can be carried out by circulating the orange juice a single time or in a loop in the anion exchange column;

FIG. 6: is a graphical presentation of the flow rate and pH of a pressed juice measured over time during a high volumetric flow rate acid removal process of the invention;

FIG. 7: is a graphical presentation of the flow rate and pH of a commercial juice measured over time during a high volumetric flow rate acid removal process of the invention;

FIG. 8: shows HPLC profiles of the eluates recovered after regeneration of the weak anion exchange resin for a pressed orange juice deacidified by a classical elution on a weak anion exchange resin and the high volumetric flow rate acid removal process of the invention;

FIG. 9: is a graphical presentation of the flow rate and pH of a commercial juice measured over time during a high volumetric flow rate acid removal process of the invention;

FIG. 10: shows an HPLC profile of the eluates recovered after regeneration of the weak anion exchange resin for a commercial orange juice deacidified by a high volumetric flow rate acid removal process of the invention co-injected with samples of citric acid and ascorbic acid at concentration of 10 g/L;

FIG. 11: shows an HPLC profile of selected saccharides and organic acids over eluted total bed volume obtained by eluting a commercial juice on a strong cation exchange resin in accordance with the sugar-reducing process of the invention;

FIG. 12: shows an HPLC profile of total % amount of cumulated selected saccharides over the eluted orange juice; and

FIG. 13: shows a comparative HPLC profile of total % amount of cumulated selected saccharides over the eluted orange juice at 4° C. and 60° C.

### DETAILED DESCRIPTION

High Volumetric Flow Rate Acid Removal from Orange Juices

“BV” is the acronym for “bed volume”, i.e., the volume of resin in the column. Also, in the technical field of circulating fluids in columns filled with resins, the flow rate of the fluid is commonly expressed as BV/hour. This has the advantage of indicating the flow rate in a normalized manner, i.e., irrespective of the volume of the column.

As used herein the pH of a juice at the exit of a column (pHe) in a deacidification process is intended to refer to the pH of a deacidified juice read after being eluted on a weak anion exchange resin but before a container comprising cumulated/combined deacidified juice.

A pH of a deacidified juice designated pHd refers to pH of cumulated/combined deacidified juice in accordance with the process described herein. pHd is generally preferably obtained from substantially homogenized (e.g. by any way of shaking or mixing) cumulated/combined deacidified juice.

During the deacidification process as provided herein, the circulation flow rate of the juice in the column containing an anion exchange resin can vary while remaining comprised between 5 BV/hour and 450 BV/hour, preferably 5 BV/hour and 250 BV/hour, or more preferably 5 BV/hour and 150 BV/hour.

In one embodiment, the volume loading (in BV) of orange juice relative to the volume of resin can be adapted by the person of ordinary skill. The exchange capacity of the weak anion exchange resin being fixed, and defined by the number of active sites available, for a lower pH variation requirement, and at a given target pH, the working capacity expressed in BV increases. For example, at a given exchange capacity of approximately 1.4 equivalents per liter of resin, a BV of orange juice at an initial pH of about 4.3-4.4 may be about double when requesting an decrease of 1 pH unit compared to 0.5 pH units, (e.g. go from about 25 BV to about 50 BV).

In order to assess the total maximum loading capacity of the resin, the total acidity can be assessed using a sodium hydroxyde solution (e.g. at a concentration of 1 mol/L) on a sample of orange juice (e.g. 10 mL) until a determined deacidified pH (pHd) is reached using equation (1):

$$Loading = \frac{{Capa}_{50} * E}{{C}_{Na OH} * {V}_{NaOH}} \qquad ( 1 )$$

Loading: is the loading capacity expressed as BV (bed volume);
Capa50: 50% of theoretical capacity (ex. as provided by the resin manufacturer −1.4 eq./L in the case of Lewatit® 55221) expressed as eq/L;
CNaOH: sodium hydroxyde solution concentration expressed as eq/L;
VNaOH: volume of sodium hydroxyde solution expressed in ml to reach the determined deacidified pH;
E: volume of orange juice to deacidify expressed in ml.

In one embodiment, a loading of juice on the resin (in BV) is preferably ranging from the 75% to 125% of the calculated loading capacity or preferably 75% to 100% of the calculated maximum loading capacity.

During the method described herein, an anion exchange resin is used to capture acids in order to deacidify the juice. More specifically, an exchange occurs in the column of an anion on an adsorbent (namely the resin, which is a polymer) against another anion.

The resin for use in the deacidification of orange juice is a weak anion exchange resin. For example, the weak anion exchange resins are ternary amines that are neutral at a pH greater than 10 and ionized at a pH lower than 10. Consequently, it is understood that a weak exchange resin refers to a resin whose cation function is dissociated based on the pH of the solution.

Weak anion exchange resins have the advantage of being very specific to weak acids and multivalent acids. Yet as explained above, the orange juice to be deacidified comprises citric having three pKas (i.e., the acidity constant) of about pKa1: 2.9, pKa2: 4.3-4.4, and pKa3: 5.2 at 25° C. and ascorbic acid having a pKa of about 4.1-4.2.

As encompassed herein, “weak acid” refers to an acid that is not completely dissociated in water. An acid is weaker when its pKa is higher.

Preferably, the anion exchange resin is an exchange resin of the acrylic or styrene type. Advantageously, it is an anion exchange resin of the acrylic type. The acrylic-type anion exchange resin preferably has a capacity between 1.6-3.2. The resin also has an initial exchange speed equal to or greater than +0.10 unit of pH/minute observed after 5 minutes of contact of the juice to be deacidified with the resin in a volume ratio of 5:1 (juice: resin). The particle size of the resin varies between 300 and 600 μM.

One example of a weak anion exchange resin of the acrylic type is the CR5550 model marketed by the company DOW CHEMICAL under the trade name AMBERLITE®.

Preferably, the circulation of the orange juice to be deacidified is done in an up flow column. In the field of ion exchange resins, it is quite traditional to implement circulation of the juice to be treated in the up flow mode, when the resin captures chemical species (in the case at hand, weak acids). Indeed, when the resin captures species, it increases in volume and the fact that the circulation of the juice is in the up flow mode prevents pressure increase phenomena that could block this expansion of the resin.

In one embodiment of the method, the pH of the deacidified juice at the exit of the column (pHe) does not exceed pH 5 for any substantial period of time, for example no more than one pH reading over consecutive pH readings at regular intervals of 5 minutes.

Preferably, the pHd value of the deacidified juice is comprised between about 4 and less than about 5, preferably less than about 4.6 or from about 4.2 to about 4.6.

The selective capture of a portion of citric acid and preserve ascorbic acid during the deacidification process according to the invention is particularly advantageous. Indeed, it is necessary to remove some of the citric acid to deacidify the orange juice and make it more readily acceptable to persons with sensitive stomachs without dilutions and/or additions of other sugars or buffers, but it is desirable to maintain a sufficient amount of citric acid and as much as possible of the other components, such as ascorbic acid, that also have beneficial health and/or flavor properties for the juice.

In addition, the deacidification process herein allows for maintaining the pH of the juice below a pH efficient to prevent growth of microorganisms, such as below about 4.6.

In light of the pKa values of the citric and ascorbic acids, the pH of the deacidified orange juice at the exit of the column (pHe), if one wishes to selectively capture a portion of the citric acid, may about pKa1 citric acid <pHe<pKa2 citric acid.

The deacidification process as provided herein does not require partial deactivation of the reactivity of the anion exchange resin using an acid (e.g., using a solution comprising citric acid, malic acid, ascorbic acid or a combination of the latter).

In one embodiment, the process is comprising a step for pretreatment of the orange juice to be deacidified.

This pretreatment step may consist of clarifying the juice using any existing technique fully within the reach of one skilled in the art. Examples of these clarification techniques include centrifugation and filtration (in particular membrane, diatom or plate filtration).

For example, the clarification is advantageously done until obtaining a juice having a turbidity below 500 NTU (Nephelometric Turbidity Unit), preferably below 100, still more preferably below 25 NTU.

This pretreatment step has the advantage of preventing clogging of the column. The pulp will be or can be re-injected in juice after processing.

A step for regeneration of the anion exchange resin can be carried out in order to be able to perform, with this same resin, another deacidification of a juice.

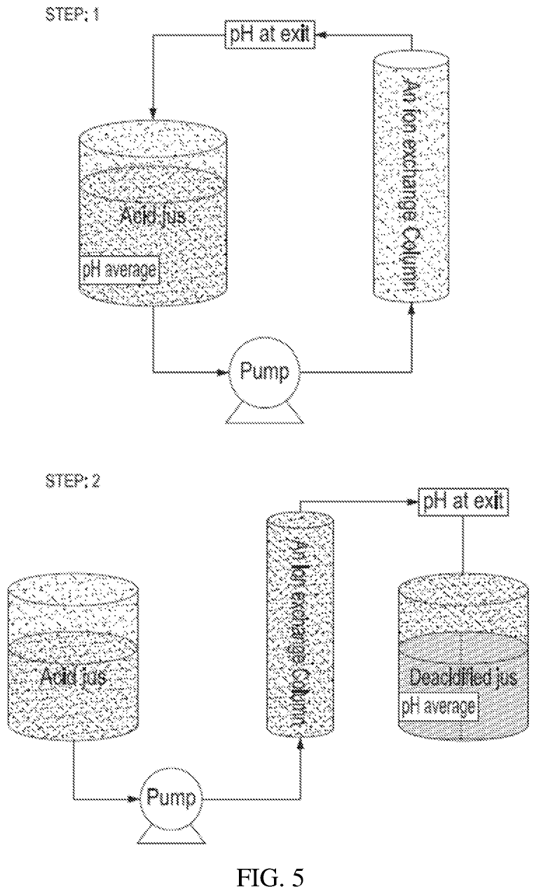

FIG. 5 schematically shows a device in which the deacidification process can be carried out according to a first embodiment in which the cranberry juice to be deacidified circulates a single time in the anion exchange column.

FIG. 5 also schematically shows a device in which the deacidification method as encompassed herein can be carried out according to a second embodiment in which the cranberry juice to be deacidified circulates in a loop in the anion exchange column.

FIG. 5 is schematically showing embodiments according to which the deacidification process can be conducted, whereby the schemes in FIG. 5 are comprising:
a container configured to contain the orange juice to be deacidified, and in a loop mode, deacidified orange juice;
a pH meter within the container for measuring the pH of the juice combined/cumulated in the container;
a column comprising a resin, the column having an entry for allowing the juice to enter the column and eluate on the resin, and an exit for allowing the eluted juice to exit the column, circulate from an entry to get in contact with the resin, and to an exit;
a pump for pumping the juice from the container to entry of the column;
a pH meter for measuring the pH of the juice at the exit of the column;
in single circulation mode, a container configured to recover/contain the deacidified orange juice.

From pH values at the exit of the column measured by the pH meter, calculations from an algorithm can deliver a flow rate command signal to the pump such that the circulation flow rate of said juice in the column is adjusted at a desired flow rate.

In one embodiment, the deacidification device comprises a plurality of columns, for example preferably between 2 and 10, still more preferably between 3 and 6. The implementation of a plurality of columns is known by those skilled in the art.

In one embodiment, said orange juice to be deacidified is circulated in a loop between said container configured to contain the orange juice to be deacidified and the column. In this embodiment, the container configured to contain the juice to be deacidified and the container for receiving the deacidified juice are a same and single container as schematically displayed in stage 1 of FIG. 5.

In one embodiment, said orange juice is circulated partially in a loop, such that after leaving the column whereby a first part of the deacidified juice rejoins the container configured to contain the juice to be deacidified, and a second part of the deacidified juice joins the container for receiving deacidified juice. The implementation of partial circulation in a loop is known by those skilled in the art.

In another embodiment, the juice to be deacidified is circulated just once in said column as schematically displayed in stage 2 of FIG. 5.

The embodiments as described above, namely implementing a plurality of columns, as well as circulation in a loop and a single passage in the column or, if applicable circulation in a partial loop, can be combined.

### Deacidified Orange Juice

The deacidified juice in accordance to an embodiment, does not contain added sugars, masking agents, such as a base or a chelating agent, or buffer.

Preferably, the pH of the deacidified juice is comprised between about 4 and less than about 5, preferably less than about 4.6 or from about 4.2 to about 4.6.

### Optional Concentration of Deacidified Orange Juice

At the end of the deacidification stage, the process may further comprise a step of concentrating the deacidified orange juice using one or more techniques such as reverse osmosis or evaporation which are within the reach of one skilled in the art.

The deacidified orange juice, may therefore be concentrated or not prior to performing a sugar-reducing process.

For example deacidified orange juice may have a concentration index comprised between about 5 and about 65 degrees Brix, preferably between about 35 and about 50 Brix or around 50 Brix.

### Sugar Reduction of Deacidified Orange Juice

The resin may be strong acid cation resin. The resins are composed of a polystyrene matrix with a sulphonate (SO3-) functional group.

In one embodiment, the strong acid cation resin has a capacity ranging from about 1.4 to 1.8 equivalents per liters.

The strong cationic exchange resin is preferably conditioned prior to the sugar reduction process. The conditioning can be done using a citric acid/citrate-containing aqueous solution at/or between pHi and pHd, wherein pHi is the pH of the orange juice to be deacidified and pHd is the pH of deacidified orange juice, the conditioning being before the sugar reduction process. For example, the resin can be conditioned using a conditioning volume of an orange juice, or a deacidified orange juice, or buffered citric acid solution, wherein the juice or solution is either at pH between about 3 to about 5, preferably a deacidified orange juice at the pHd: pHi+(0.1-1)]<pHd<5, preferably between about 4.3 and 4.6.

The resin is preferably conditioned using a buffered citric acid solution, preferably at pHd as defined herein, between about 4.3 and 4.6.

The resin is preferably conditioned using from about 1 to 3 BV of the above conditioning solution.

The resin is also preferably washed out with water after the conditioning.

Following conditioning of the strong cationic exchange resin, a volume of orange juice (preferably deacidified in accordance to the process described herein) is eluted on the resin. Preferably, a volume loading of orange juice is from about 1% to about 10%, more preferably about 5% of the volume of the resin.

The process provides for selectively recovering a first fraction of the sugar-reduced orange juice, comprising about 50% to about 70% by weight of the total sugar amount of the such as recovering xBV of said eluted orange juice wherein x is ranging from 0.1 to 0.8, to provide a sugar-reduced orange juice.

The process further provides for additionally recovering a second fructose-enriched fraction from eluting the deacidified orange juice.

Within the step of eluting a volume of deacidified orange juice to be sugar-reduced, the step is comprising eluting said volume of deacidified orange juice on the resin followed eluting with water, preferably deionized water, until the recovered first fraction is comprising about 30% to about 80% by weight of the total sugar amount of the deacidified orange juice.

Preferably the elution of orange juice is on a column comprising the strong cation exchange resin, the elution is in a top to bottom direction. The elution rate can preferably be from about 1 to about 10 BV/h, or from about 2 to about 5 BV/h, or about 4 to about 5 BV/h.

Preferably the elution of orange juice is on a column comprising the strong cation exchange resin, whereby the juice is cooled at a desired temperature (preferably below about 30° C., or below about 20° C., or below about 10° C. but in all cases above the freezing point of water and for example at about 4° C., at standard atmospheric pressure) before the elution step and/or the column comprising the strong cation exchange is thermostated (e.g. by means of a jacketed column).

### Deacidified and Sugar Reduced Orange Juice

In a further embodiment, the disclosure is comprising a deacidified and sugar reduced orange juice composition prepared by the process as defined herein.

### Orange Juice Product Comprising Deacidified and Sugar Reduced Orange Juice

The present disclosure also relates to an orange juice product that comprises deacidified and sugar reduced orange juice, for example deacidified and sugar reduced, as described or as prepared herein.

In orange juice products herein, the deacidified and sugar reduced orange juice, may concentrated or not, for example having a concentration index that may be comprised between 3 and 65 degrees Brix, and preferably about 10 Brix to 50 Brix.

### EXAMPLES

### Analytical Methods

The orange juices/products were characterized by the following methods:
Rapid determination of dry matter by refractometry (degree brix): because a dissolved solid in solution modifies the refractive index of the liquid proportionally to their concentration, it was possible to measure the solute concentration from a refractometer calibrated for sucrose. A drop of liquid at 20° C. was placed on the cell of the REICHERT R²I300, and the reading directly provided the relevant value.
Monitoring of salts by conductivity (noted a).
Monitoring of UV absorbance as molecules in solution absorb certain wavelengths, it is possible to measure the absorption, which is proportional to the concentration in solution. The wavelength is set at 420 nM, the solution was filtered on a 0.45 μm filter and diluted such that the absorbance would not exceed 1 Unit. The cell was filled and placed in the cell holder of the VWR UV/VIS 1600PC spectrophotometer. The result is expressed directly in Absorbance Unit.
Determination of organic acids (citric and ascorbic acid) and sugars (sucrose, glucose and fructose) by HPLC. Column: BIORAD HPX87K 7.8*300 mm; Eluent: K₂HPO₄ 0.13 g/L, at 0.6 ml/min, 80° C. Acids in solution acidify the medium if they are not in a salt form. titration with NaOH using a phenolphthalein indicator, allowed the determination of free acids content. 50 ml of the solution was withdrawn and 5 drops of phenolphthalein were added and titrated with 1M a volume (V) of NaOH until the color indicator changed. Free acidity=V/50 (expressed in mole/liter).

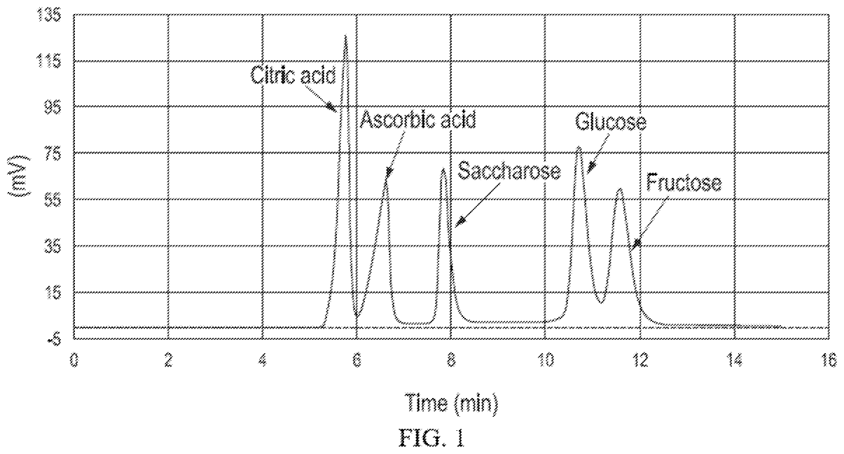

FIG. 1 shows HPLC profile of a solution composed of citric and ascorbic acid as well as sucrose, glucose and fructose in the same solution at a concentration of 5 g/L.

Citric acid comes out at about the same time as the salts, its concentration may therefore be slightly overestimated. Sucrose, in addition to its main peak at 7.83 minutes, presents peaks overlapping with glucose and fructose. In the remainder of the study, these peaks were attributed to glucose or fructose, thus underestimating sucrose in favor of other species (˜20%).

### Extraction

The orange juice was extracted from orange fruits using a centrifuge equipped with a 0.5 mm sieve and at a rotation speed of 3000 rpm (50 Hz).

### Preparation of Orange Juice

Each pressed juice was prepared on day required for the experiment to be conducted. The oranges were grossly peeled and introduced into the centrifuge. The collected juice was filtered first on a cloth filter cone to remove coarser particles, then by filtration through a Buchner filter headed by a 30 μm filter.

Table 1 shows the characterization of the orange juices.

### Characterization of Pressed and Commercial Juices

Table 1 shows the characterization of the orange juices. The commercial orange juice is more concentrated than the pressed orange juice, with a ° Brix and a dry matter of 12.4 and 11.22 respectively, against 10 and 10.26 for the pressed juice. The pH of the commercial orange juice is also about 0.2-0.3 pH units higher than that of the pressed juice.

TABLE 1

| | | Dry Matter | | Conductivity | Absorbance (420 nm) | |
|---|---|---|---|---|---|---|
| Jus | ° Brix | (%) | pH | (Ms/cm) | unfiltered | filtered |
| Pressed Batch 1 | 10.1 | 10.26 | 3.39 | 1.53 | 7.99 | 0.13 |
| Pressed Batch 2 | 9.2 | 9.33 | 3.3 | 1.39 | 7.27 | 0.58 |
| Commercial 1* | 12.4 | 11.22 | 3.62 | 1.63 | 14.8 | 4.37 |

*commercial source orange juice sold by Andros ™, « fresh », without pulp

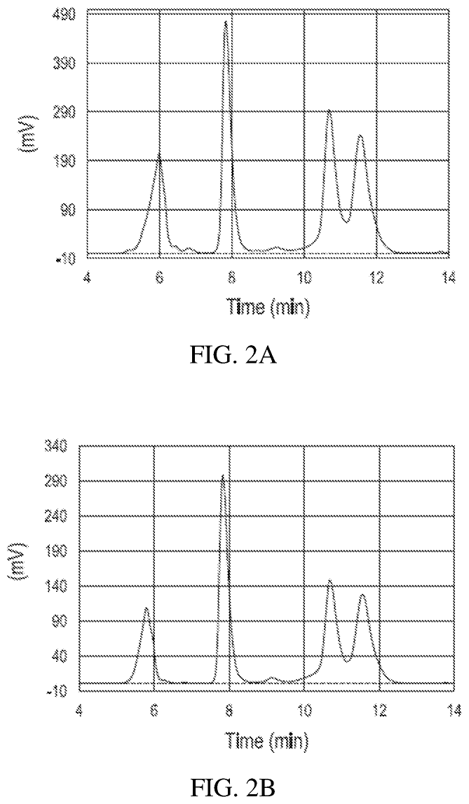

FIG. 2 shows the HPLC profile of pressed juice (undiluted, 0.45 μm filtration) and the commercial juice (50% dilution, 0.45 μm filtration). As observed in table 2, the pressed and commercial orange juices have quite similar compositions having regard to the sugar composition, with 27 to 31.5% of sucrose and about 25% of glucose and fructose. The commercial juice is comprised of more citric and ascorbic acids in % than the pressed juice, but their concentration is higher in pressed juice for a Brix which is however lower.

TABLE 2

| | Concentration by HPLC (g/L) | | | | |
|---|---|---|---|---|---|
| | Citric | Ascorbic | | | |
| | acid | acid | Saccharose | Glucose | Fructose |
| Pressed Batch 1 | 16.24 | 0.60 | 43.72 | 21.92 | 20.69 |
| Commercial 1 | 14.40 | 0.26 | 49.44 | 24.21 | 22.69 |
| | % (w/w - on a dry matter basic) | | | | |
| | Citric | Ascorbic | | | |
| | acid | acid | Saccharose | Glucose | Fructose |
| Pressed Batch 1 | 15.80 | 0.28 | 31.45 | 25.17 | 25.18 |
| Commercial 1 | 19.03 | 0.52 | 26.91 | 25.64 | 25.78 |

### Reference Example 1—Classical Ion Exchange Deacidification of Pressed Juice

The assay produced a deacidified orange juice having an increased pH of +1 pH unit compared to the initial juice (i.e. a pH of 4.49/4.3 for the pressed juices and 4.62 for commercial juice)

To determine the exchange capacity of the S5221 resin, the orange juice was eluted on the resin and the assay was stopped when the pH at the outlet of the column reached the initial pH of the juice to deacidify, meaning that the resin was then saturated with no further exchange capacity.

### Resin Used for Deacidification:

| Commercial name | | Type of | Ionic | Capacity |
|---|---|---|---|---|
| of resin | Manufacturer | resin | form | (eq/L) |
| Lewatit ® S5221 | Lanxess | Weak anionic | OH⁻ | 1.4 eq/L |

### Ion Exchange

The ion exchange was carried out on a glass column (H=35 cm, Ø=2 cm) connected to a peristaltic pump 0-150 mL/min.

The resin was first regenerated using the following method:

| | | Flow rate | Volume |
|---|---|---|---|
| | Entry | (BV/h) | (BV) |
| Saturation (only at 1st regeneration) | HCl 1N | 2 | 2 |
| Wash | water | 2 | 2 |
| Regeneration | NaOH 1N | 2 | 3 |
| Slow wash | water | 2 | 2 |
| Rapid wash | water | 10 | 10 |

Once the resin was rinsed off, the pressed filtered juice (Batch 1) was passed from top to bottom through 85 mL of Lanxess 55221 resin in OH— form in a column at a rate of 2 BV/h. Samples were taken at the column outlet all the BV. After reaching saturation, the resin was regenerated following the protocol cited above (except for the HCl step).

Table 3 summarizes the juice profiles observed before and after deacidification with ion exchange

TABLE 3

| | | V | Brix | σ | | DM | DM | Abs (420 nm) | |
|---|---|---|---|---|---|---|---|---|---|
| | | L | ° B | mS/cm | pH | % | kg | unfiltered | filtered |
| IN | Pressed Batch 1 | 3.23 | 10.1 | 1.53 | 3.39 | 10.3 | 0.345 | 7.99 | 0.13 |
| OUT | Deacidified | 3.956 | 9.1 | 1.44 | 4.44 | 9.3 | 0.379 | 8.64 | 1.06 |
| | Pressed Batch 1 | | | | | | | | |

| | | citric | ascorbic | saccharose | fructose | glucose |
|---|---|---|---|---|---|---|
| | | g/L | g/L | g/L | g/L | g/L |
| IN | Pressed Batch 1 | 16.59 | 0.29 | 33.01 | 26.43 | 26.42 |
| OUT | Deacidified | 10.61 | 1.43 | 31.04 | 20.97 | 28.32 |
| | Pressed Batch 1 | | | | | |

DM: Dry Matter;
Abs: Absorbance

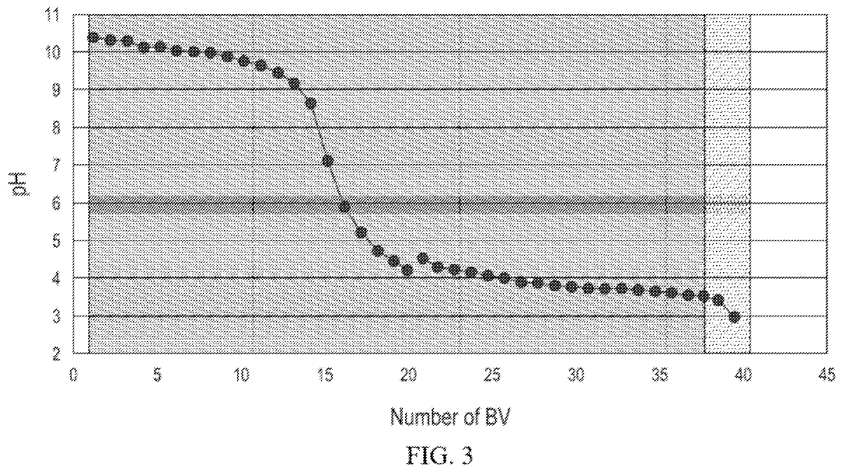

As shown in FIG. 3, in accordance with what was expected, the pH of the juice at the beginning of the ion exchange is very high, between 10.4 and 9 from BV 1 to BV 13.5. The results show a sharp drop in pH between BV 13 and 17, dropping from 9 to less than 5.5, the resin is showing a loss of capacity. After this sharp drop in pH, a plateau is reached and the decrease in pH at the column outlet is very slow and it was necessary to extend the process to BV 38 to be able to reach the pH of the juice pressed at the column inlet, that is more than 20 BV of juice to go from a pH of 5.2 to 3.4.

Ion exchange therefore has the significant drawback of greatly varying the pH of the juice during the process. Also, citric acid and ascorbic acid are found in significant amounts in the regeneration eluate, meaning that those were both captured during ion exchange treatment.

### Reference Example 2: Classical Ion Exchange Deacidification of Commercial Juice

### Commercial Juice (Commercial 1):

The juice was first centrifuged at 2150×g for 10 minutes to separate the precipitate from the juice. Indeed, the fine pulps tend to clog the column. The juice was therefore only eluted on the resin after the pulps had been removed. The pulp can however be reintroduced into the deacidified juice at the end of the process.

The ion exchange process here was carried out in the same way as in Reference example 1 above.

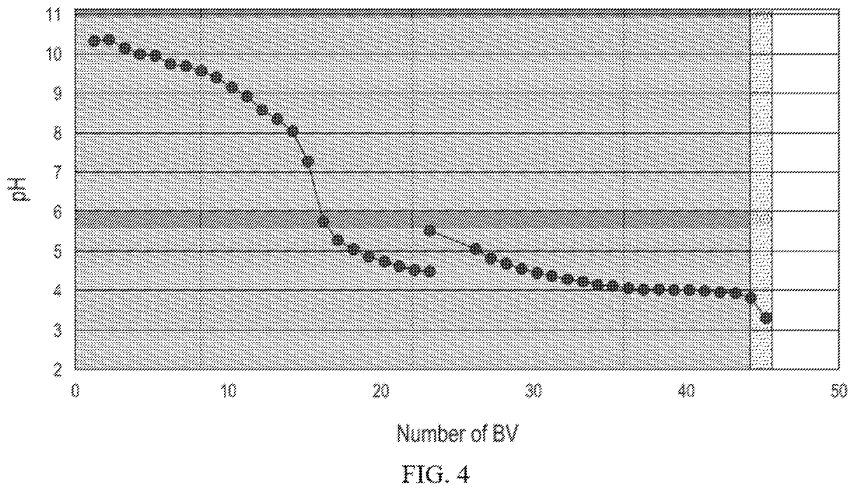

As shown in FIG. 4, similarly to what was observed in Reference example 1, the pH of the juice at the beginning of the exchange was very high, between 10.3 and 8.6 from BV 1 to BV 12. The curve then showed a sharp drop in pH from 8 to less than 5 between BV 14 and 19, indicating a loss in the resin capacity. After this sharp drop, a plateau was reached around the 34th BV and the decrease in pH at the column outlet is very slow and the initial juice pH was not reached after 43 BV (3.8 for 3.42).

Table 4 summarizes the juice profiles observed before and after deacidification with ion exchange

TABLE 4

| | | V | Brix | σ | | DM | DM | Abs (420 nm) | |
|---|---|---|---|---|---|---|---|---|---|
| | | L | ° B | mS/cm | pH | % | kg | unfiltered | filtered |
| IN | Commercial 1 | 3.71 | 12.4 | 1.63 | 3.59 | 11 | 0.44 | 14.8 | 4.37 |
| OUT | Deacidified | 4.189 | 10.6 | 1.63 | 4.68 | 11 | 0.46 | 12.65 | 1.73 |
| | Commercial 1-IEX | | | | | | | | |

| | | citric | ascorbic | saccharose | fructose | glucose |
|---|---|---|---|---|---|---|
| | | g/L | g/L | g/L | g/L | g/L |
| IN | 1 Commercial 1 | 24.75 | 0.68 | 35.00 | 33.34 | 33.53 |
| OUT | Deacidified | 11.62 | 0.25 | 36.85 | 29.21 | 29.60 |
| | Commercial 1-IEX | | | | | |

DM: Dry Matter;
Abs: Absorbance

Once again, the process had the significant drawback of greatly varying the pH of the juice during the process. Also, citric acid and ascorbic acid were found in significant amounts in the regeneration eluate, giving evidence that both were captured during ion exchange process.

### Example 1: High Volumetric Flow Rate Acid Removal from Orange Juices

The assay produced a deacidified orange juice at a pH of +1 compared to the initial juice.

The resin used for the deacidification is:

| Commercial name | | Type of | Ionic | Capacity |
|---|---|---|---|---|
| of the resin | Manufacturer | resin | form | (eq/L) |
| Lewatit ® S5221 | Lanxess | Weak anionic | OH⁻ | 1.4 eq/L |

### Filtration/Centrifugation

The pressed juice (Pressed Batch 2) was filtered on a cloth filter cone to remove coarser particles, then by filtration through a Buchner having a 30 μm filter.

Measurement of the load capacity of the resin:

### Loading

In order to size the pilot tests, an acidity assay was carried out on the two types of orange juice. For this, a titrating solution of sodium hydroxide (e.g. at 1 mol/l) is added to a sample of orange juice (e.g. 10 mL) until pHi+1 pH unit is reached. The volume of NaOH is measured and the proton concentration obtained makes it possible to determine the maximum load of orange juice in the anionic resin using Equation (1) above.

### Batch 2 Pressed Orange Juice

During the titrimetric assay, 2.5 mL of IN NaOH had to be added to 50 mL of pressed juice to reach pHi+1. This corresponds to a maximum load of 28 BV. Based on experience with previous tests on other fruits, we decided to reduce this value by approximately 10%, or 25 BV load. The operating conditions are therefore summarized in table 5

TABLE 5
Operating conditions

| Resin volume | 60 mL |
|---|---|
| Loading | 1.5 L: 25 BV at 9.2 ° B |
| Initial pH | 3.36 |
| Target deacidified pH | 4.36 |

Deacidification using the high volumetric flow rate acid removal process was performed at laboratory scale on a glass column (H=37 cm, Ø=2.5 cm) connected to a 0-150 mL/min peristaltic pump.

The required assembly can be used in a loop (i.e. the juice passed on the resin is returned to the container containing the orange juice to be deacidified) or not. The circulation flow rate is adjusted so that the pH at the exit of the column does not exceed the target pH by more than 1 pH unit. This avoids a significant variation in pH which would cause a change in color and a risk of precipitation of molecules. Once the exit pH has stabilized at the set point, it is no longer necessary to return the (partially) deacidified juice to the container and the deacidified juice is collected directly in a container configured to recover/contain the deacidified orange juice (FIG. 5). Thus the exchange between the resin and the acid juice is promoted and the production time is reduced compared to the above recycling.

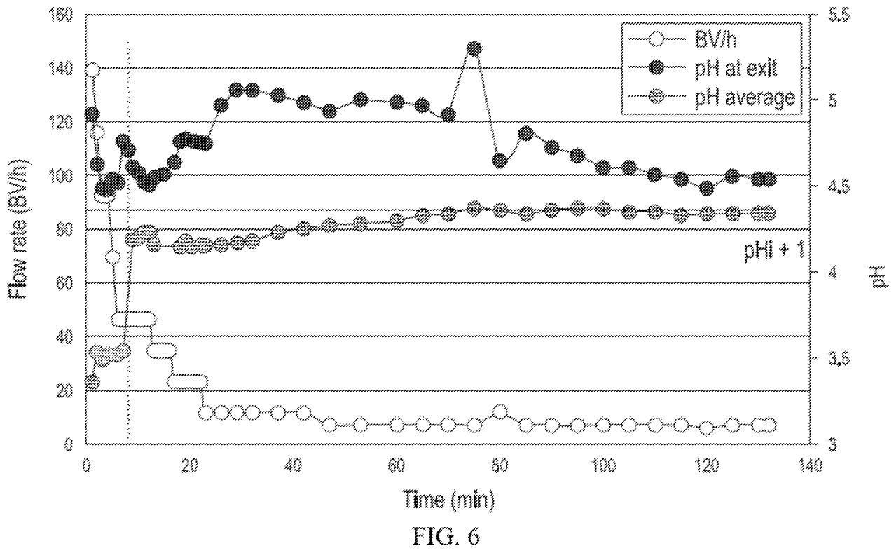

FIG. 6 shows a graph monitoring the flow rate of the juice as well as the pH at the exit of the column and the pH of the recovered/collected deacidified orange juice pH during deacidification of the pressed juice. The dotted horizontal line represents the target pH and the vertical line represents the interruption of the loop mode circulation.

The target pH of 4.36 was reached. The loop mode was interrupted after 8 minutes. The pH of the deacidified orange juice peaked above a pH of 5 (i.e. pH of 5.3) only at a single point, but otherwise remained under than 5.

After 23 minutes, the initial flow rate was reduced by nearly 92% to reach an average pH of 4.16 (i.e. pHi+0.8). From 47 minutes, the flow rate was set at 96% of its initial value and remained constant almost throughout the end of the test. From 65 minutes, the pHi+1 is reached and remains constant until the end of the deacidification which lasted 132 minutes.

Table 6 summarizes the juice profiles observed before and after deacidification

TABLE 6

| | | V | Brix | σ | | DM | DM | Abs (420 nm) | |
|---|---|---|---|---|---|---|---|---|---|
| | | L | ° B | mS/cm | pH | % | kg | unfiltered | Filtered |
| IN | Pressed Batch 2 | 1.44 | 9.2 | 1.39 | 3.3 | 9.3 | 0.135 | 7.27 | 0.58 |
| OUT | Deacidified | 1.44 | 9.5 | 1.49 | 4.29 | 9.2 | 0.132 | 7.82 | 0.66 |
| | Pressed Batch 2 | | | | | | | | |

| | | citric | ascorbic | saccharose | fructose | glucose |
|---|---|---|---|---|---|---|
| | | g/L | g/L | g/L | g/L | g/L |
| IN | Pressed Batch 2 | 17.49 | 0.28 | 25.82 | 23.89 | 23.32 |
| OUT | Deacidified | 9.76 | 1.30 | 29.84 | 25.13 | 26.69 |
| | Pressed Batch 2 | | | | | |

DM: Dry Matter;
Abs: Absorbance

Importantly, an HPLC analysis of the regeneration eluate confirmed that no ascorbic acid was found in the regeneration eluate, meaning that no ascorbic acid was lost or captured by the resin during the high volumetric flow rate acid removal process. This is in sharp contrast with the results observed in Reference examples 1 and 2 above that showed a significant loss of ascorbic acid.

### Commercial (Commercial 1) Orange Juice

In the same manner as for Batch 2, the commercial juice (designated here as “commercial 1”) was deacidified.

Prior to the deacidification operations, the maximum load which allows the pH to be raised by 1 unit was determined as described above.

During the titrimetric experiment, 2.6 mL of IN NaOH was added to 50 mL of the commercial juice Andros juice to reach pHi+1. This corresponds to a maximum load of 27 BV.

The operating conditions are therefore summarized in Table 7

TABLE 7
Operating conditions

| Resin volume | 60 mL |
|---|---|
| Loading | 1.3 L: 21.7 BV at 12.4 ° B |
| Initial pH | 3.62 |
| Target deacidified pH | 4.62 |

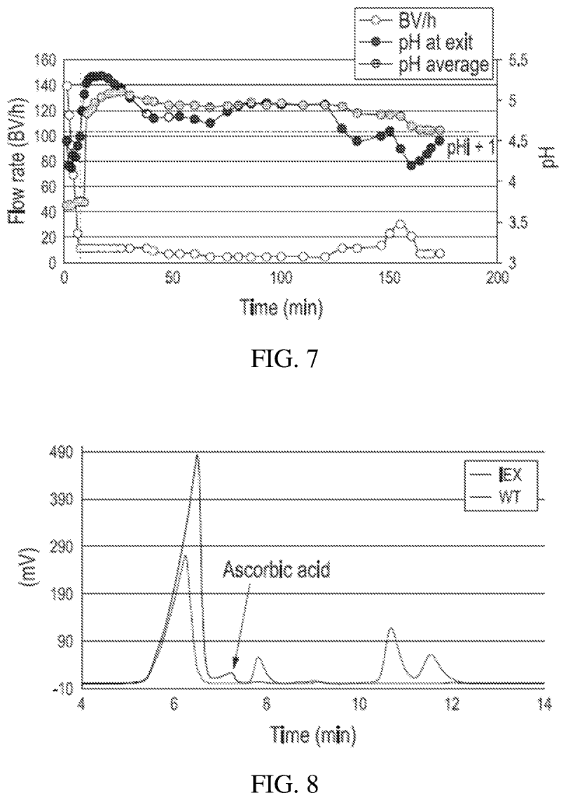

FIG. 7 shows a graph monitoring the flow rate of the juice as well as the pH at the exit of the column and the pH of the recovered/collected deacidified orange juice pH during deacidification of the pressed juice. The dotted horizontal line represents the target pH and the vertical line represents the interruption of the loop mode circulation.

The target pH of 4.62 was reached. The loop mode was interrupted after 7 minutes. After 7 minutes of flow processing, the flow rate was reduced by nearly 92%. The average pH reaches the value of pHi+1 after 173 minutes.

Table 8 summarizes the juice profiles observed before and after deacidification.

TABLE 8

| | | V | Brix | σ | | DM | DM | Abs (420 nm) | |
|---|---|---|---|---|---|---|---|---|---|
| | | L | ° B | mS/cm | pH | % | kg | unfiltered | Filtered |
| IN | Commercial 1 | 1.26 | 12.4 | 1.63 | 3.62 | 11.2 | 0.1420 | 14.8 | 4.37 |
| OUT | Deacidified | 1.26 | 1.04 | 1.59 | 4.7 | 10.3 | 0.1298 | 12.77 | 0.8 |
| | Commercial 1 | | | | | | | | |

| | | | Ascorbic | | | |
|---|---|---|---|---|---|---|
| | | Citric acid | acid | saccharose | fructose | glucose |
| | | g/L | g/L | g/L | g/L | g/L |
| IN | Commercial 1 | 14.40 | 0.26 | 49.44 | 24.21 | 22.69 |
| OUT | Deacidified | 8.05 | 0.70 | 55.00 | 21.90 | 20.23 |
| | Commercial 1 | | | | | |

DM: Dry Matter;
Abs: Absorbance

An HPLC analysis of the regeneration eluate confirmed that no ascorbic acid was found in the regeneration eluate, meaning that no ascorbic acid was lost or captured by the resin during the high volumetric flow rate acid removal process. This is in sharp contrast with the results observed in Reference examples 1 and 2 above that showed a significant loss of ascorbic acid.

Observations Regarding the Classical Ion Exchange and High Volumetric Rate Acid Removal from Orange Juice:

In sharp contrast with the above Reference examples 1 and 2 above, using a classical ion exchange process, the high volumetric flow rate acid removal process described herein did not cause a loss of ascorbic acid on the resin.

FIG. 8 shows the HPLC profile of the regeneration eluate recovered after deacidification of the pressed juice under the classical ion exchange process (Reference examples 1 and 2) and the process described herein. The profiles show that indeed no ascorbic acid is recovered in the elutate after the deacidification process described herein is performed on the orange juice.

The finding is surprising in that the skilled person would expect a portion of the citric acid to be removed because the deacidified juice has a pH of about 4.3, that is the pH is greater than the first pKa of citric acid. However, essentially no ascorbic acid is removed in the process, despite the fact that the pKa is generally very close (i.e. pKa ac. ascorbic about 4.1-4.2) to the pH of the processed deacidified juice (or pH is even higher at some time points).

Further, the finding is especially surprising since when a cranberry juice was processed in order to raise the pH from about 2.5 to about 3.5 which expectedly caused malic acid (i.e. pKa of about 3.4) to be removed in part.

### Example 2: High Volumetric Flow Rate Acid Removal from Further

### Commercial (Commercial 2) Orange Juice

In order to show versatility and accuracy of the process, a second commercial juice was deacidified using the high volumetric rate acid removal process, a further experiment was conducted but with larger volumes of orange Juice and a smaller increase in pH.

### Analytical Methods

The determination of dry matter by refractometry, conductivity (noted σ) and pH was done in a manner and using equipment similar to what is described above.

The total sugar content was assessed by HPLC-RI on a biorad column, model HPX87K, using water and K2HPO4 (0.13 g/l), at a temperature of 80° C. and flow rate of 0.6 ml/min.

The citric acid content was assessed by HPLC-RI on a biorad column, model HPX87K, using water and H2SO4 (0.48 g/l), at a temperature of 60° C. and flow rate of 0.6 ml/min.

A second, different commercial juice was used in this example. Before high volumetric flow rate acid removal process, the orange juice was centrifuged to reduce the suspended matter (pulps) in order to prevent risks of clogging the resin and column.

Centrifugation of the concentrate is carried out by a rotor centrifuge with a capacity of 2 liters for 15 minutes at 3000 rpm (2150×g). The pulps are separated from the supernatant and then stored in the freezer at −18° C.

Table 9 is characterizing the juice obtained after centrifugation.

TABLE 9

| | | volume | weight | DM | | Salts/acids | saccharose | glucose | fructose | citrique |
|---|---|---|---|---|---|---|---|---|---|---|
| | | I | kg | % | kg | g/l | g/l | g/l | g/l | g/l |
| IN | Commercial 2* | 43.0 | 44.866 | 11.12% | 4.99 | 11.87 | 43.50 | 20.39 | 23.94 | 6.59 |
| OUT | Supernatant | 39.9 | 41.620 | 10.70% | 4.45 | 11.78 | 43.00 | 20.09 | 23.63 | 6.61 |
| | commercial 2 | | | | | | | | | |
| | solid | | 1.698 | 25.41% | 0.43 | | | | | |
| OUT/IN | | | | | 97.9% | 92.1% | 91.7% | 91.4% | 91.6% | 93.1% |

*commercial source orange juice sold by JokerTM “orange juice without pulp”

The table above shows the centrifugation material balance. From the point of view of total dry matter (DM) there are no losses during this operation.

The composition of the centrifuged juice does not vary from that of the juice

Initial as shown in Table 10.

TABLE 10

DO à 420 nm

| | Brix | pH | σ | Filtered | Crude |
|---|---|---|---|---|---|
| Orange juice | 11. | 3.92 | 3.77 | 0.30 | 13.79 |
| Supernatant | 11.1 | 3.95 | 3.83 | 0.25 | 5.96 |

In order to size the maximum loading capacity, the free acidity of the orange juice was measured. A sodium hydroxide solution (e.g. at 1 mol/l) can be used in a titration of a sample of the orange juice (e.g. 10 ml of orange juice) until the target pH was reached (+0.5 pH unit). The maximum load of orange juice was calculated as described above.

To perform the deacidification process, the following resin was used:

| Commercial name | | Type of | Ionic | Capacity |
|---|---|---|---|---|
| of the resin | Manufacturer | resin | form | (eq/L) |
| Lewatit ® S5221 | Lanxess | Weak anionic | OH⁻ | 1.4 eq/L |

The high volumetric flow rate acid removal process was carried out with a pilot consisting of a stainless steel column section 78.5 cm² an eccentric screw pump of 400 l/h, a supply tank of 10 liters and two pH meters located at the exit of the column outlet and in the feed tank.

The operating conditions are:

| Volume of orange juice to | 48 | litres |
|---|---|---|
| be deacidified | | |
| Free acidity | 0.026 eq/l at pH 4.4 | |
| Loading | 54 BV at pH 4.4 | |
| Resin capacity | 1.4 | eq/l |
| Resin volume | 740 | ml |

The pH of the orange juice to be deacidified is 3.9. The deacidification process target is to raise the pH of +0.5 units. 740 ml of resin (or 54 BV) for 48 liters of juice was used.

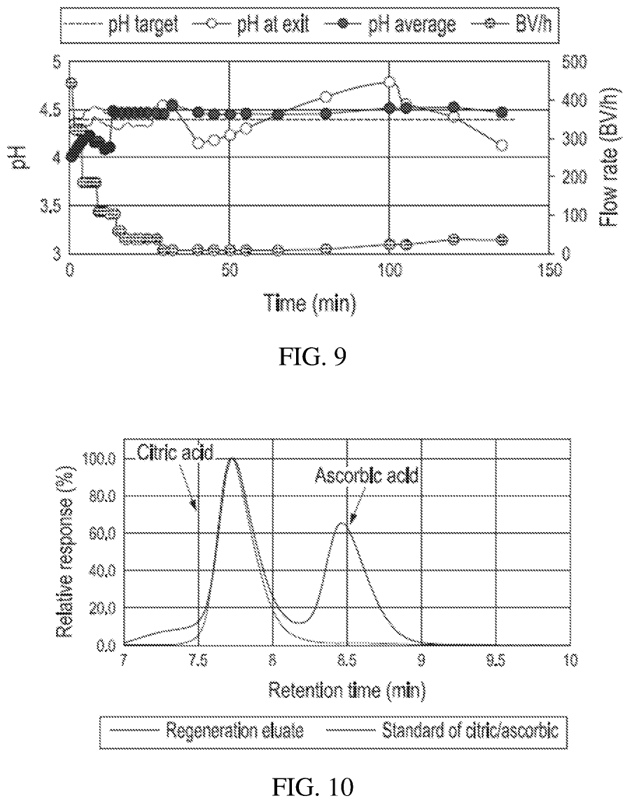

The flow rate of juice in the column was adjusted during the process to limit strong pH variations. As shown in FIG. 9, the pH at the exit of the column does not exceed 5 during the process.

A summary of the HPLC analysis of the deacidified orange juice is provided in Table 11.

TABLE 11

| | | volume | weight | DM | | Salts/acids | saccharose | glucose | fructose | citrique |
|---|---|---|---|---|---|---|---|---|---|---|
| | | I | kg | % | kg | g/l | g/l | g/1 | g/l | g/l |
| IN | Supernatant | 39.9 | 41.620 | 10.70% | 4.45 | 11.78 | 43.00 | 20.09 | 23.63 | 6.61 |
| | commercial 2 | | | | | | | | | |
| OUT | Deacidified | 39.9 | 40.880 | 10.33% | 4.22 | 8.93 | 42.43 | 19.75 | 23.30 | 5.20 |
| | Supernatant | | | | | | | | | |
| | commercial 2 | | | | | | | | | |
| | regeneration | 4.4 | 4.470 | 0.00% | 0 | 0 | 0 | 0 | 0 | 5.73 |
| OUT/IN | | | | | 94.8% | 75.8% | 98.7% | 98.3% | 98.6% | 86.9% |
| % captured | | | | | | | | | | 11.1% |

The material balance of citric acid is slightly deficient, however, a significant amount is measured in the regeneration eluate which represents 11% of the citric acid recovered in the two fractions.

The regeneration eluate being free of glucose, ascorbic acid becomes quantifiable, FIG. 10 (comparison of the chromatograms of the regeneration eluate and of a standard of citric acid+ascorbic at 10 g/1) does not show a specific peak for ascorbic acid. Ascorbic acid was therefore not captured during the deacidification process.

Observations Regarding the High Volumetric Flow Rate Acid Removal from the Commercial Orange Juice:

As discussed in Example 1, an analysis of the regeneration eluate showed that there is no ascorbic acid present, confirming that no ascorbic acid is captured in the process, unlike the result of the process under the classical ion exchange.

The finding is surprising in that the skilled person would expect a portion of the citric acid to be removed because the deacidified juice at the output of the column sometimes has a pH ranging between 4 and 5 which is very close or higher than the pKa of ac. Ascorbic.

### Example 3: Sugar Removal from Orange Juice

The deacidified orange juice obtained from example 1 (i.e. Deacidified Commercial 1) is concentrated on a rotavap under vacuum at about 25 Brix.

The operating conditions are:

| Commercial name | | Type of | Ionic | Capacity |
|---|---|---|---|---|
| of the resin | Manufacturer | resin | form | (eq/L) |
| DOWEX 99/220 | DuPont | Strong cationic | H⁺ | ≥1.8 eq/L |

500 ml of resin was loaded in a double-cased glass column and adjustable pistons equipped with 200 μm fits (H=100 cm, 0=2.5 cm). The resin was then regenerated with the following method:

| | | Flow rate | Volume |
|---|---|---|---|
| | Entry | (BV/h) | (BV) |
| Regeneration | HCl 1N | 2 | 2 |
| Slow wash | water | 2 | 2 |
| Rapid wash | water | 10 | 5 |

After the above regeneration, 3 BV of the commercial juice 1 (i.e. without prior deacidification) described in Example 1 above was eluted through the resin in the column at a flow rate of 20 mL/min and a temperature of 60° C. This step, prior to the step of eluting the deacidified juice for removing/reducing sugar from the deacidified orange juice, may be referred to as “conditioning” of the strong cation exchange resin, and is believed to bring the resin into chemical equilibrium with the orange juice.

The deacidified commercial juice 1 obtained in Example 1 above was concentrated at 25° B by evaporation in a rotavapor and then 25 mL of the concentrated deacidified orange juice was eluted the column at 60° C. and at flow rate of 20 mL/min, followed by deionized water at 60° C., also at 20 mL/min flow rate. Samples were taken every 20 mL and analyzed to accurately calculate retention time and separation resolution between peaks.

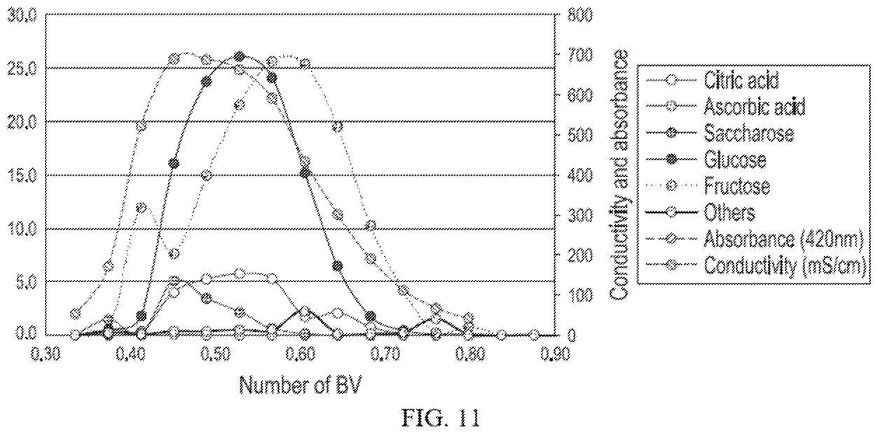

FIG. 11 shows the elution profile of sugars, and organic acids.

It was observed that sucrose comes out before glucose which itself comes out before fructose. Thus, the 1st fraction will mainly contain sucrose, glucose and less fructose compared to fraction 2. The majority of citric acid came out at the beginning of the elution but it is also found in the fractions between 0.6 and 0.7 BV in significant amounts.

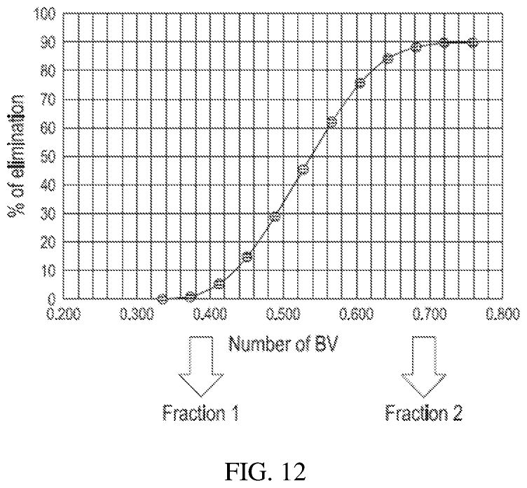

FIG. 12 shows the cumulative % amount of sugars recovered. The analysis showed that it had been possible to eliminate 50% of the total sugars from the deacidified orange juice using a cut-off value of about 0.54 BV.

The process was repeated several times to confirm the efficiency and the various recovered fractions 1 and 2 were combined and concentrated by rotavapor to a degree ° B of 7 (which corresponds to the Brix value of the initial commercial orange juice with about 50% less of total sugars).

The analysis showed that fraction 1 was composed mainly of glucose (46.2%) and sucrose (13.0%), fructose (28.3%) while fraction 2 contained a large majority of fructose (56.3%).

Quite surprisingly, ascorbic acid is only detected in fraction 1 which allows to again maintain this important vitamin in the sugar-reduced fraction.

TABLE 12

| | | | | | | | | | | Weight % |
|---|---|---|---|---|---|---|---|---|---|---|
| | | | % (w/w - on a dry matter basis) | | | | | | g | of |
| | | | Citric | Ascorbic | | | | | Total | sugar/initial |
| | ° B | V (L) | acid | acid | Saccharose | glucose | fructose | Others | sugars | content |
| Entry | 25 | 0.1 | 10.29 | 0.27 | 34.96 | 25.54 | 27.1 | 1.84 | 24.18 | |
| Fraction 1 | 2.5 | 0.523 | 10.41 | 0.24 | 13.0 | 46.22 | 28.34 | 1.79 | 11.56 | 47.8 |
| Fraction 2 | 2.4 | 0.573 | 8.62 | 0 | 1.10 | 32.44 | 56.33 | 1.51 | 12.47 | 51.5 |

Two fractions with approximately 50% sugar are obtained: a 1st fraction containing a large part of the organic acids and sucrose+glucose/fructose and a 2nd fraction depleted in organic acids and sucrose and containing mainly fructose (more than 50%).

### Example 4: Sugar Removal from Orange Juice

The deacidified orange juice obtained from Example 2 (i.e. Deacidified supernatant Commercial 2) is concentrated by nanofiltration and reverse osmosis. The intermediate concentration operations are carried out using a nanofiltration pilot. The skid includes a 20 liter feed tank, 15 l/min piston pump and organic membrane Dow NF 270 filter housing. The product is concentrated at a pressure of 50 bar. Until reaching the critical temperature of 40° C. It can be seen that the brix curve of the retentate has a slope similar to that of the temperature and under these conditions the product was concentrated to about 35° B. Table 13 provides a summary of the profile of the concentrated juice.

TABLE 13

| | | volume | masse | MS | | salts/acids | saccharose | glucose | fructose | citric |
|---|---|---|---|---|---|---|---|---|---|---|
| | | I | kg | % | kg | g/l | g/l | g/l | g/l | g/l |
| IN | deacidified | 37.3 | 38.88 | 10.33% | 4.02 | 8.93 | 42.43 | 19.75 | 23.30 | 5.20 |
| OUT | concentrated | 10.2 | 10.62 | 32.22% | 3.42 | 28.89 | 156.9 | 60.89 | 71.54 | 13.21 |
| | deacidified | | | | | | | | | |
| | supernantant | | | | | | | | | |
| | commercial 2 | | | | | | | | | |
| | permeat | 25.5 | 29.05 | 1.73% | 0.50 | 2.26 | 2.27 | 4.99 | 5.84 | 1.22 |
| OUT/IN | | | | | 97.7% | 105.9% | 104.9% | 101.7% | 101.2% | 85.5% |

| | | | | | | |
|---|---|---|---|---|---|---|
| % recovery in | 87.2% | 83.6% | 96.5% | 83.0% | 83.1% | 81.2% |
| concentrated | | | | | | |

In view of the material balance above, it can be seen that most of the sucrose is retained in the permeate while monomers and organic acids are recovered in the retentate. The color is almost all retained in the retentate. The pH of the resulting concentrated deacidified orange juice is not significantly changed and was assessed at pH=4.19.

The sugar removal step was conducted using the following resin:

| Commercial name | | Type of | Ionic | Capacity |
|---|---|---|---|---|
| of the resin | Manufacturer | resin | form | (eq/L) |
| DOWEX 99/220 | DuPont | Strong cationic | H⁺ | ≥1.8 eq/L |

The resin is conditioned with a citric acid solution buffered at the pH of the solution to be deacidified and then washed with deionized water:

| | | volume | Flow |
|---|---|---|---|
| | | (BV) | rate |
| Conditioning | Buffered citric acid | 1 | 200 ml/min* |
| | (pH 4.40) | | (0.8 BV/h) |
| Washing | deionized water | 2 | |

5% of the volume of resin (ie 750 ml) of concentrated deacidified juice was eluted on 15 liters of resin. The column (h=195 cm, diam=10 cm) and the incoming products are thermostated at 4° C. The flow rate was set at 200 mL/min.

As discussed in Example 3, samples were taken and analyzed. It was observed that the peak resolution at 4° C. was spread out more. It is believed that the temperature changed the kinetics of sorption and desorption of molecules on the resin.

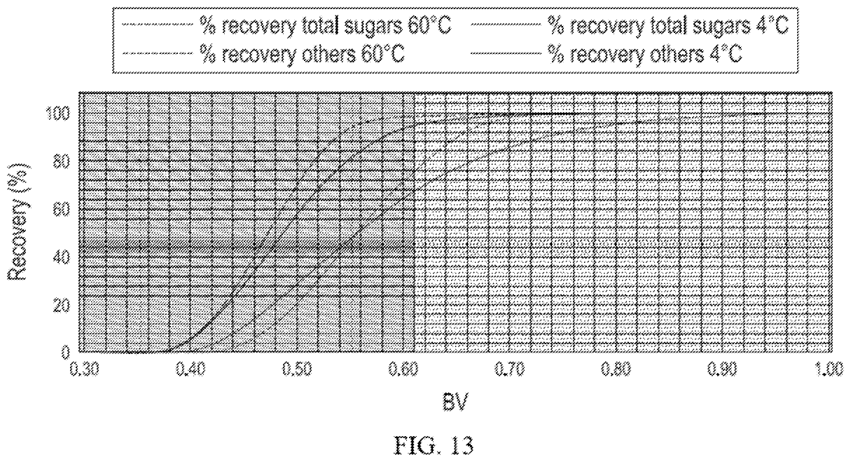

FIG. 13 shows a comparison of the curves obtained at 4 and 60 degrees Celsius. FIG. 13 shows the recovery of total sugars (glucose, fructose and sucrose) and other molecules (mineral/organic salts, organic acids) as a function of eluted volume. It is noted that independently of the temperature, 50% recovery of sugars was obtained at 0.56 BV.

It was further possible to tailor the amount of recovered acids and salts in the first fraction as a function of the recovered processed orange juice. For example, at 0.56 BV, 98% of the mineral/organic salts and organic acids was recovered at 60° C. reaches, and 81% of those were recovered at 4° C.

Not only was the temperature variation allowing to tailor the required recovery of the various components, but selecting a different collected volume cut-off further provide control on the composition of fraction 1. For example, a cut-off value at 0.61 BV allowed to recover more of salts/acids while eliminating 31% of the total sugars (i.e. 69% of the sugars was recovered in fraction 2).

The process was repeated several time to confirm the reproducibility and flexibility of the conditions. Table 14 is summarizing the profiles of injections nos. 2 and 8 for cut-offs at 0.58 BV, 0.61 BV and 0.70 BV:

TABLE 14

| | injection no | 2 | 8 |
|---|---|---|---|
| Salts/acids | 0.58 BV + | 1% | 1% |
| | 0.61 BV + | 8% | 9% |
| | 0.70 BV | 16% | 17% |
| Total sugars | 0.58 BV + | 15% | 15% |
| | 0.61 BV + | 36.8% | 35.7% |
| | 0.70 BV | 47% | 46% |
| Saccharose | 0.58 BV + | 5% | 5% |
| | 0.61 BV + | 15.9% | 15.1% |
| | 0.70 BV | 25% | 24% |
| Glucose | 0.58 BV + | 12% | 12% |
| | 0.61 BV + | 44.7% | 43.2% |
| | 0.70 BV | 59% | 58% |
| Fructose | 0.58 BV + | 41% | 40% |
| | 0.61 BV + | 77.4% | 76.1% |
| | 0.70 BV | 51% | 51% |

Table 15 shows that there was no significant loss in the material balance caused by the process. Further, at 4° C. sucrose didn't invert to glucose and fructose since the sugar ratios remained balanced.

The conditions therefore not only allowed to tailor the composition of the recovered deacidified/sugar reduced orange juice, but it maintained the equilibrium of sugars very close to that found in the commercial or pressed juices originally implemented in the processes. This is therefore suggesting that there was no significant saccharose inversion.

TABLE 15

| | | | | | | Salts/ | | | | Citric |
|---|---|---|---|---|---|---|---|---|---|---|
| | | volume | mass | DM | | acids | saccharose | glucose | fructose | acid |
| | | I | kg | % | kg | g/l | g/l | g/l | g/l | g/l |
| IN | Concentrated | 9.7 | 9.76 | 32.22% | 3.15 | 28.89 | 156.9 | 60.89 | 71.54 | 12.76 |
| | deacidified | | | | | | | | | |
| | juice | | | | | | | | | |
| OUT | Fraction 1 | 49.9 | 50.19 | 4.13% | 2.07 | 4.86 | 26.62 | 6.63 | 3.32 | 2.29 |
| | Fraction 2 | 80.1 | 81.39 | 1.32% | 1.07 | 0.27 | 2.80 | 2.98 | 6.23 | 0.12 |
| OUT/IN | | | | | 100.0% | 94.1% | 101.8% | 96.3% | 95.7% | 99.9% |

| | | | | | | |
|---|---|---|---|---|---|---|
| % recovery in Fraction 1 | 65.9% | 91.8% | 85.5% | 58.1% | 24.9% | 92.2% |

While the present disclosure has been described in connection with specific embodiments thereof, it will be understood that it is capable of further modifications and this application is intended to cover any variations, uses, or adaptations, including such departures from the present disclosure as come within known or customary practice within the art and as may be applied to the essential features hereinbefore set forth, and as follows in the scope of the appended claims.

1. A process for deacidifying an orange juice comprising:
eluting the orange juice to be deacidified on a weak anion exchange resin to lead to a deacidified orange juice after elution;
wherein the orange juice to be deacidified has an initial pH (pHi) and is eluted on said resin at a rate (BV/h) such that the deacidified orange juice has a pH (pHd) meeting the criteria:
[pHi+(0.1-1)]<pHd<[pKa ascorbic acid+(0.1-0.5)].

2. The process of claim 1, wherein said process further comprises
eluting a conditioning effective amount of a citric acid/citrate-containing aqueous solution on a strong cation exchange resin to provide a conditioned resin and subsequently eluting the orange juice to said conditioned resin; and
recovering a first fraction of sugar-reduced orange juice after said step of eluting, wherein said first fraction is comprising about 30% to about 80% by weight of the total sugar of deacidified.

3. The process of claim 1, wherein the orange juice is loaded on the resin ranging from the 75% to 125% of the calculated loading capacity of said resin.

4. (canceled)

5. The process of claim 1, wherein the weak anion exchange resin comprises ternary amines that are neutral at a pH greater than 10 and ionized at a pH lower than 10.

6. The process of claim 1, wherein the anion exchange resin is made of acrylic or styrene.

7. The process of claim 6, wherein the anion exchange resin is made of acrylic comprises a capacity between 1.6-3.2.

8. The process of claim 6, wherein the anion exchange resin is made of a polystyrene matrix with a sulphonate (S03) functional group.

9. The process of claim 1, wherein the resin has an initial exchange speed equal to or greater than +0.10 unit of pH/minute observed after 5 minutes of contact of the juice with the resin in a volume ratio of 5:1 (juice: resin).

10. The process of claim 1, wherein the resin comprises particle sizes between 300 and 600 μM.

11. The process of claim 1, wherein the resin is AMBERLITE®.

12. The process of claim 1, wherein the orange juice is circulated in an up flow column during elution.

13. The process of claim 12, wherein the pH of the deacidified juice at the exit of the column (pHe) does not exceed pH 5.

14. The process of claim 12, wherein the pHd value of the deacidified juice is comprised between about 4 and less than about 5.

15. (canceled)

16. The process of claim 12, wherein the pHd value of the deacidified juice is about 4.6.

17. The process of claim 1, further comprising pretreatment of the orange juice to be deacidified.

18-19. (canceled)

20. The process of claim 17, wherein the juice is clarified to a turbidity below 500 NTU (Nephelometric Turbidity Unit.

21-22. (canceled)

23. The process of claim 1, further comprising the step of regenerating the anion exchange resin.

24. The process of claim 1, further comprising concentrating said deacidified orange juice.

25. (canceled)

26. A juice deacidification system for deacidifying an orange juice according to the process of claim 1 comprising:
a container configured to contain the juice to be deacidified;
a pH meter within the container for measuring the pH of the juice in the container;
at least one column comprising a resin, the column having an entry for allowing the juice to enter the column and eluate on the resin, and an exit for allowing the eluted juice to exit the column, circulate from an entry to get in contact with the resin, and to an exit;
a pump for pumping the juice from the container to entry of the column; and
a pH meter for measuring the pH of the juice at the exit of the column.

27-29. (canceled)

30. A deacidified orange juice prepared by the process of of claim 1.

31-32. (canceled)
